(19) United States
(12) Patent Application Publication
(10) Pub. No.: US 2023/0316210 A1
(43) Pub. Date: Oct. 5, 2023

(54) POLICY DECISION SUPPORT APPARATUS AND POLICY DECISION SUPPORT METHOD

(71) Applicant: Hitachi, Ltd., Chiyoda-ku, Tokyo (JP)

(72) Inventor: Junichi MIYAKOSHI, Tokyo (JP)

(21) Appl. No.: 18/023,132

(22) PCT Filed: Oct. 7, 2021
(86) PCT No.: PCT/JP2021/037233

§ 371 Date: Feb. 24, 2023

(30) Foreign Application Priority Data
Jan. 12, 2021 (JP) 2021-002766

(51) Int. Cl. G06Q 10/067

(52) U.S. Cl. CPC G06Q 10/067

(57) ABSTRACT

A policy decision support apparatus that includes a processor configured to execute a program and a storage device configured to store the program, and is configured to support policy decision based on a plurality of indices, the processor being configured to execute: a generation process of expressing the plurality of indices as nodes and expressing, for every two indices among the plurality of indices, superiority or inferiority between the two indices as an edge connecting the two nodes to generate a graph modeling a relationship between the plurality of indices; and a calculation process of calculating an importance level of each of the plurality of indices based on the graph generated in the generation process.

### CLAIM OF PRIORITY

The present application claims priority from Japanese pat. application No. 2021-2766 filed on Jan. 12, 2021, the content of which is hereby incorporated by reference into this application.

### BACKGROUND

The present invention relates to a policy decision support apparatus and a policy decision support method for supporting policy decision.

In recent years, in the sustainable development goals SDGs, which were formulated to solve global social issues, it is expected to achieve sustainable development in a form in which the three values of society, environment, and economy are balance and integrated. For this reason, it is necessary to quantitatively evaluate the impact of a company’s business on the social, environmental, and economic value axes, and to carry out activities to improve the values.

To achieve the above, for example, it is possible to objectively quantify environmental values such as carbon dioxide emissions and economic values such as corporate profits. On the other hand, social values includes objective aspects such as disparities and fairness, as well as subjective aspects such as the continuity of local culture through regional development, the quality of life of local residents, and their sense of happiness. Therefore, the quantification of social values requires the quantification of subjective aspects such as values. Here, the values are an index represented by a preference relationship such as like/dislike, importance/unimportance of things.

Value quantification techniques are often used to assess consumer values regarding marketing. JP2005-502932T discloses a system for quantifying consumer preferences, in which relative importance of a plurality of product attributes is evaluated according to consumer instructions such as the least important attribute, the most important attribute, and other attributes, and a value representing the consumer’s preference for a particular attribute level.

When quantifying values for a plurality of policies targeting regions and organizations, the number of indices may become extremely large. When dealing with a large number of indices, in the method disclosed in JP2005-502932T, it was difficult to handle relationships in which the superiority or inferiority between each index and another index is ranked such as one prefers index B to index A, prefers index C to index B, prefers index A to index C, and so on.

### SUMMARY

An object of the present invention is to quantify the relationship between a plurality of indices.

A disclosure of a policy decision support apparatus in the present application is a policy decision support apparatus that includes a processor configured to execute a program and a storage device configured to store the program, and is configured to support policy decision based on a plurality of indices, the processor being configured to execute: a generation process of expressing the plurality of indices as nodes and expressing, for every two indices among the plurality of indices, superiority or inferiority between the two indices as an edge connecting the two nodes to generate a graph modeling a relationship between the plurality of indices; and a calculation process of calculating an importance level of each of the plurality of indices based on the graph generated in the generation process.

According to representative embodiments of the present invention, it is possible to quantify the relationship between a plurality of indices. The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWING

FIG. 1 is an explanatory diagram showing a system configuration example of a policy decision support system according to the first embodiment.

FIG. 2 is a block diagram for illustrating a hardware configuration example of each of computers.

FIG. 3 is a block diagram showing a functional configuration example of the policy decision support apparatus.

FIG. 4 is a flowchart showing an example of a value model generation processing procedure by the value model generation unit.

FIG. 5 is an explanatory diagram showing a display example of questionnaire information.

FIG. 6 is a chart showing an example of aggregate results of the preference relationship survey of the residents.

FIG. 7 is an explanatory diagram showing a first example of the preference graph.

FIG. 8 is an explanatory diagram showing a second example of the preference graph.

FIG. 9 is an explanatory diagram showing an example of probability transition graph conversion from a preference graph.

FIG. 10 is an explanatory diagram showing an example (first half) of calculating eigenvalues and eigenvectors in the eigenvalue calculation process (step S405).

FIG. 11 is an explanatory diagram showing an example (second half) of calculating eigenvalues and eigenvectors in the eigenvalue calculation process (step S405).

FIG. 12 is a flowchart showing an example of a policy importance generation processing procedure by the policy importance model generation unit.

FIG. 13 is a graph showing an example of simulation results of index A for each of the 484 policies.

FIG. 14 is a graph showing an example of simulation results of index B for each of the 484 policies.

FIG. 15 is a graph showing an example of simulation results of index C for each of the 484 policies.

FIG. 16 is an explanatory diagram showing an example of pseudocode for a given index.

FIG. 17 is a graph showing the degree of improvement for each policy of the index A in the result of the policy simulation shown in FIG. 13.

FIG. 18 is a graph showing the degree of improvement for each policy of the index B in the result of the policy simulation shown in FIG. 14.

FIG. 19 is a graph showing the degree of improvement for each policy of the index C in the result of the policy simulation shown in FIG. 15.

FIG. 20 is an explanatory diagram showing an example of the improvement information of the policy with the policy number and the graph structuring process.

FIG. 21 is a graph showing the calculation results of the eigenvectors of each policy in the first embodiment.

FIG. 22 is a graph showing the degree of preference compatibility of each policy.

FIG. 23 is a graph showing the average degree of improvement of each policy.

FIG. 24 is an explanatory diagram showing an example of calculation of the matching degree of each policy.

FIG. 25 is a flowchart showing an example of a value model generation processing procedure when using a neural network.

FIG. 26 is an explanatory diagram showing a structural diagram of a neural network.

FIG. 27 is an explanatory diagram showing a display example of the value graph or the importance graph.

FIG. 28 is an explanatory diagram of a dependency model between indices based on the example of the first embodiment.

FIG. 29 is an explanatory diagram showing indices and sub-indices related to safety awareness.

FIG. 30 is an explanatory diagram showing an example of policies regarding safety awareness.

### DETAILED DESCRIPTION OF THE EMBODIMENTS

### First Embodiment

In a first embodiment, an example of regional revitalization policies will be described. The regional revitalization policies of the first embodiment target a business plan of a new electric power company, and examine the propriety of introduction of renewable energy facilities and the number of users of the new electric power company. The policy decision support system of the first embodiment is a system for supporting regional revitalization policies. Specifically, for example, the system calculates the degree of matching between the business plan and residents’ values, and provides the business plan with the highest degree of matching with the residents’ values as a policy.

In addition, in the first embodiment, a group of indices assumed for quantifying the residents’ values will be described. Specifically, the indices include, for example, household expenses related to electricity rates (for example, the total per 100 households), regional distribution rate related to regional sustainability, regional energy utilization rate related to regional environment, regional distribution amount for the entire region, total profits of companies related to the region, sales or profits of individual companies related to the region, the number or percentage of employees of companies related to the region who live in the region, and power consumption, electricity rates, or power saving effect for each household in the region.

In addition, in the first embodiment, three indices will be described representatively from the viewpoint of explanation. The three indices A to C are household expenses (index A), regional distribution ratio (index B), and regional energy utilization rate (index C). In the first embodiment, an example in which the number of indices is 3 will be described, but the calculation can also be performed when the number of indices is 2 or 4 or more.

### System Configuration Example of Policy Decision Support System

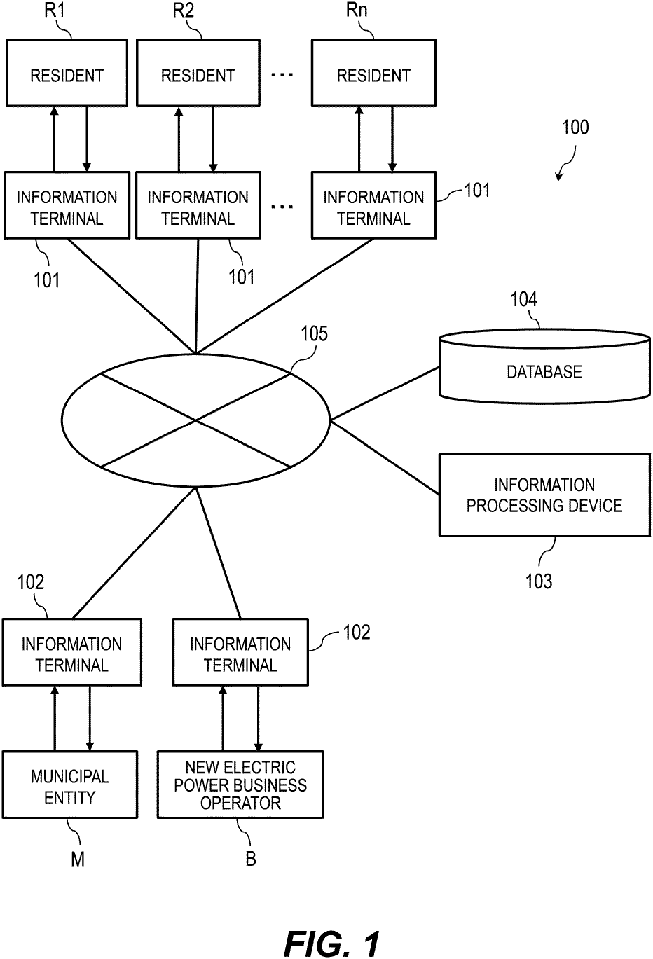

FIG. 1 is an explanatory diagram showing a system configuration example of a policy decision support system according to the first embodiment. A policy decision support system 100 has a first information terminal 101, a second information terminal 102 and a policy decision support apparatus 103. The first information terminal 101, the second information terminal 102, and the policy decision support apparatus 103 are communicably connected via a network 105 such as the Internet, a local area network (LAN), or a wide area network (WAN).

The first information terminal 101 is a computer used by residents R1 to Rn (n is an integer equal to or greater than 1; hereinafter collectively referred to as a resident R) and acquires the values of the resident R and transmits the values to the policy decision support apparatus 103. The first information terminal 101 is, for example, a communication device such as a smartphone or a personal computer.

The second information terminal 102 is a computer used by a municipal entity M and a new electric power business operator (hereinafter simply referred to as a business operator) B, and is a computer for displaying the values of the resident R from the policy decision support apparatus 103 and the degree of matching between the values of the resident R and the business plan of the business operator B. The second information terminal 102 is, for example, a communication device such as a smartphone or a personal computer.

The policy decision support apparatus 103 receives the values of the resident R from the first information terminal 101, and executes information processing related to modeling of values, simulation of business plans, and quantification. The policy decision support apparatus 103 transmits the values of the resident R and the execution result of the information processing (the degree of matching described above) to the second information terminal 102. A database 104 stores information necessary for the information processing by the policy decision support apparatus 103.

### Hardware Configuration Example of Computer

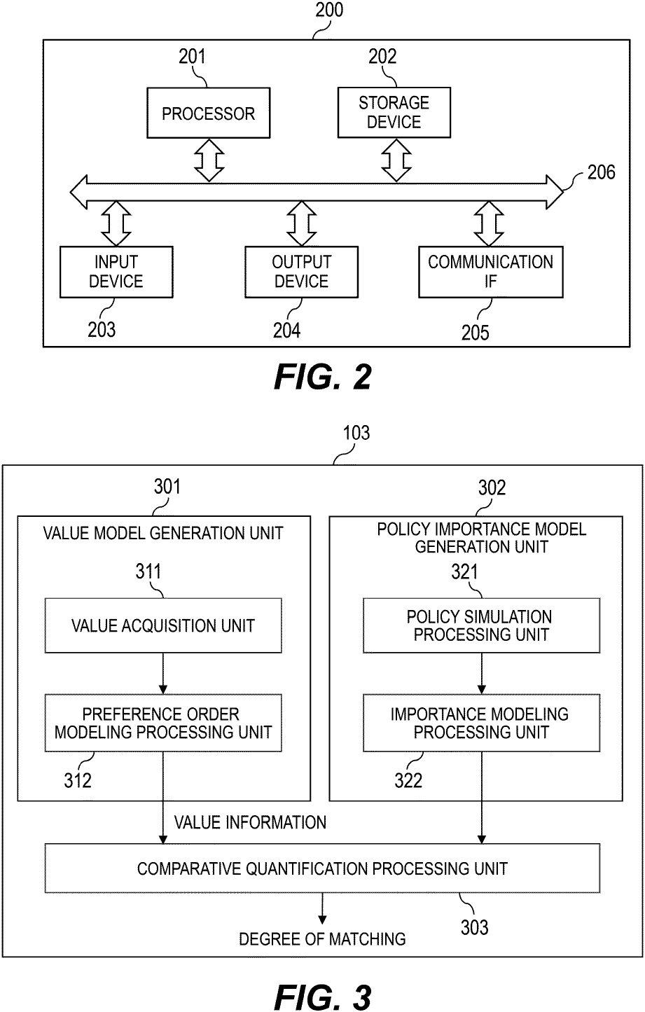

FIG. 2 is a block diagram for illustrating a hardware configuration example of each of computers (the first information terminal 101, the second information terminal 102 and the policy decision support apparatus 103). A computer 200 includes a processor 201, a storage device 202, an input device 203, an output device 204, and a communication interface (communication IF) 205. The processor 201, the storage device 202, the input device 203, the output device 204, and the communication IF 205 are coupled to one another through a bus 206. The processor 201 is configured to control the computer 200. The storage device 202 serves as a work area for the processor 201. The storage device 202 is also a non-transitory or transitory recording medium configured to store various programs and various kinds of data. Examples of the storage device 202 include a read only memory (ROM), a random-access memory (RAM), a hard disk drive (HDD), and a flash memory. The input device 203 is configured to input data. Examples of the input device 203 include a keyboard, a mouse, a touch panel, a numeric keypad, a scanner and a microphone. The output device 204 is configured to output data. Examples of the output device 204 include a display, a printer, and a speaker. The communication IF 205 is coupled to the network 110, and is configured to transmit and receive data.

### Functional Configuration Example of Policy Decision Support Apparatus 103

FIG. 3 is a block diagram showing a functional configuration example of the policy decision support apparatus 103. The policy decision support apparatus 103 has a value model generation unit 301, a policy importance model generation unit 302, and a comparative quantification processing unit 303. The policy decision support apparatus 103 may include at least either the value model generation unit 301 or the policy importance model generation unit 302 among the value model generation unit 301, the policy importance model generation unit 302, and the comparative quantification processing unit 303.

The value model generation unit 301 generates a value model of the resident R, and the policy importance model generation unit 302 estimates the degree of importance of the policy of the business operator B. The comparative quantification processing unit 303 compares the value model of the resident R generated by the value model generation unit 301 and the degree of importance of the policy of the business operator B generated by the policy importance model generation unit 302 to calculate the degree of matching. The value model generation unit 301, the policy importance model generation unit 302, and the comparative quantification processing unit 303 will be specifically described below.

### Value Model Generation Process

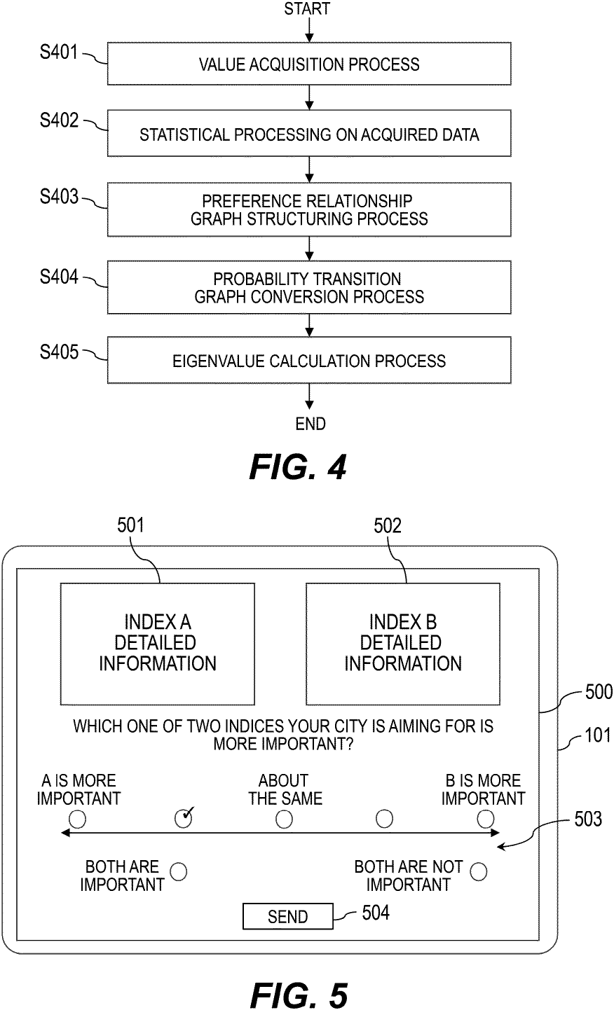

FIG. 4 is a flowchart showing an example of a value model generation processing procedure by the value model generation unit 301. The value model generation unit 301 executes a value acquisition process by the value acquisition unit 311 (step S401), and statistical processing on acquired data (step S402), a preference relationship graph structuring process (step S403), a probability transition graph conversion process (step S404), and an eigenvalue calculation process (step S405) by the preference order modeling processing unit 312.

The value acquisition process (step S401) is a process in which the value model generation unit 301 acquires the values of the residents R from the first information terminals 101. Specifically, for example, the value model generation unit 301 transmits questionnaire information to the first information terminals 101 of the residents R, and obtains the responses from the first information terminals 101.

### Questionnaire Information

FIG. 5 is an explanatory diagram showing a display example of questionnaire information. A display screen 500 is a user interface displayed on the first information terminal 101 based on the questionnaire information transmitted from the policy decision support apparatus 103. The display screen 500 displays a questionnaire performed for the purpose of acquiring the preference relationship between two indices (as an example, indices A and B in FIG. 5), employing a method (paired comparison method) of answering the degree of relative importance between two indices with 7 options (relative 5-step evaluation options and options for “both are important” and “both are not important”). Specifically, for example, the display screen 500 has index A detailed information 501, index B detailed information 502, a selection button group 503, and a send button 504.

The index detailed information 501 and the index B detailed information 502 are detailed information (character strings and images) of the indices A and B, respectively. The selection button group 503 is a group of radio buttons for selecting which of index A and index B is more important. In FIG. 5, seven radio buttons are displayed, and the resident R selects any one of the radio buttons. The send button is a button for sending the selection result of the selection button group 503 to the policy decision support apparatus 103 as the questionnaire response result when the resident R presses it.

In FIG. 5, the paired comparison method is used as a questionnaire, but relative evaluation methods such as increasing the number of options for the degree of relative importance (for example, to ten options) or displaying a plurality of indices and answering their rankings may be used.

Returning to FIG. 4, the statistical processing on acquired data (step S402) is a process in which the value model generation unit 301 acquires the questionnaire response results, which are the data acquired from the first information terminal 101, and executes statistical calculation. Specifically, for example, the value model generation unit 301 assigns numerical values to the questionnaire response results acquired for the first information terminals 101.

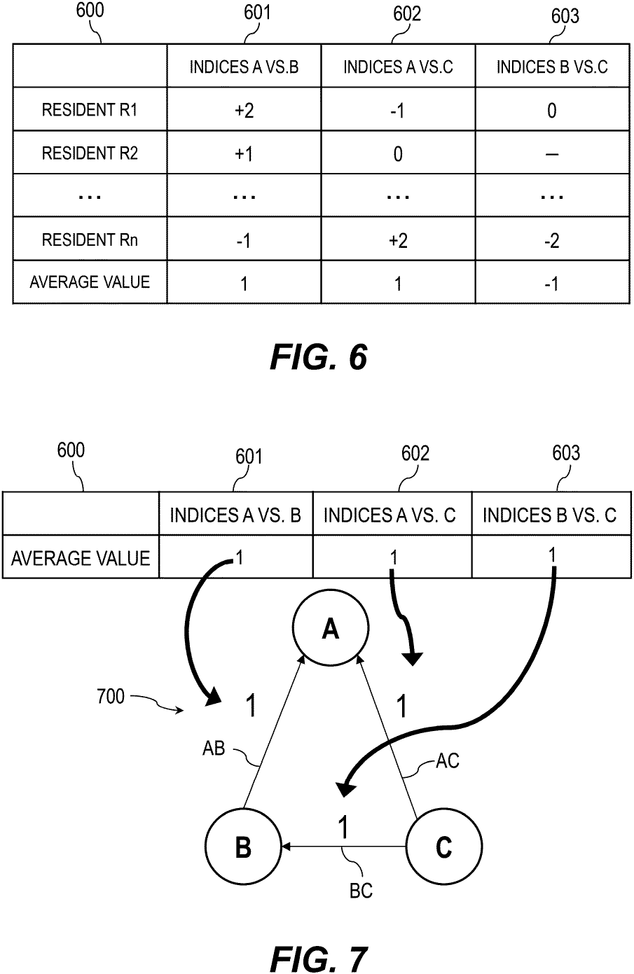

For example, when the indices A and B are paired, the options are respectively “index A is very important”, “index A is important”, “about the same”, “index B is important”, and “index B is very important,” the numerical values given to the options as the degree of relative importance are set to +2, +1, 0, -1, and -2, respectively. “Both are important” and “both are not important” are not given a value and are not included in the population of aggregate results in FIG. 6. The same applies to the case where the index pair is indices B and C and indices A and C. The value model generation unit 301 aggregates the response results of the questionnaire from the first information terminals 101 for each index pair, and outputs the aggregate results of the preference relationship survey of the residents R.

### Aggregation Results of Preference Relationship Survey of Resident R

FIG. 6 is a chart showing an example of aggregate results of the preference relationship survey of the residents R. An aggregate result 600 has the degree of relative importance of each of index pairs 601 to 603 for each resident R and the average value of the degrees of relative importance of the index pairs 601 to 603 (hereinafter referred to as an average degree of relative importance). In the degree of relative importance of each of the index pairs 601 to 603, “-” indicates that “both are important” and “both are not important” are selected. Therefore, these responses are not included in the population when calculating the average.

In addition, the average degree of relative importance of indices B vs. A is not shown in the aggregate result 600 because it can be calculated by multiplying the average degree of relative importance of indices A vs. B, which is the index pair 601, by “-1”. As another method, a method of acquiring the result of indices A vs. B and the result of indices B vs. A and averaging them is also conceivable.

Returning to FIG. 4, the preference relationship graph structuring process (step S403) is a process in which the value model generation unit 301 structures the preference relationship of each index pair in a graph form based on the aggregate result 600. Specifically, for example, the value model generation unit 301 first generates nodes corresponding to the indices A to C. The generated nodes are defined as nodes A to C. Next, edges indicating connection relationships between the nodes A to C will be described.

### Preference Graph

FIG. 7 is an explanatory diagram showing a first example of the preference graph. In the aggregate result 600, when the average degree of relative importance of indices A vs. B is “1”, the value model generation unit 301 connects the node A and node B to generate an edge AB indicating the direction from node B to node A. The edge AB is given the absolute value “1” of the average degree of relative importance of the index pair 601 (indices A vs. B). Similarly, the value model generation unit 301 generates edges BC and AC. The edge BC and edge AC are given an absolute value “1” of the average degrees of relative importance of the index pair 602 (indices B vs. C) and the index pair 603 (indices A vs. C). In this way, a preference graph 700 is generated.

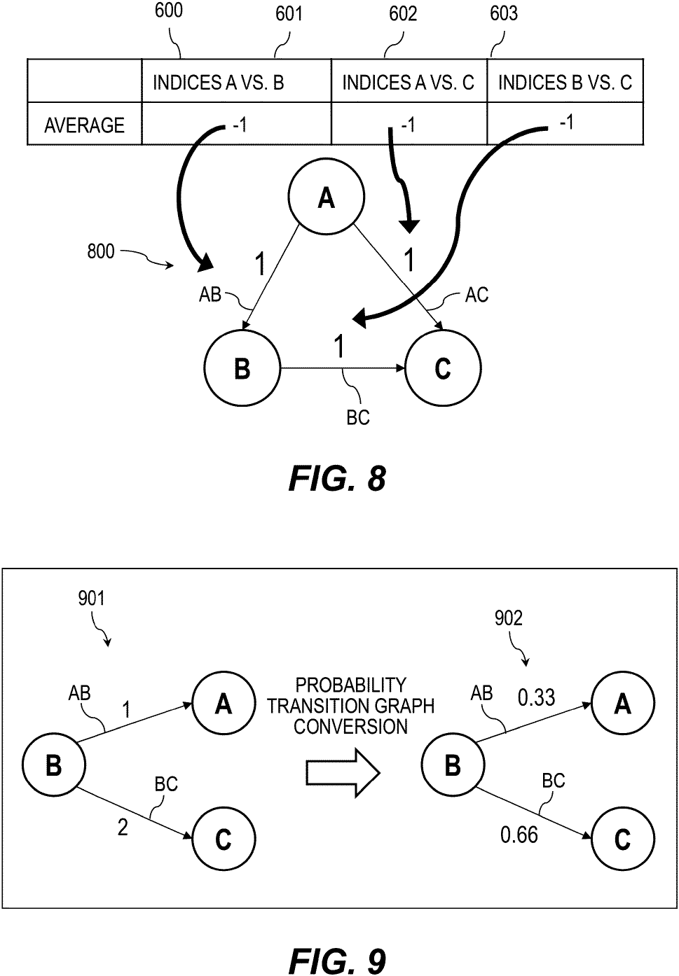

FIG. 8 is an explanatory diagram showing a second example of the preference graph. A preference graph 800 is a graph in which the directions of the edge AB, BC, and AC of the preference graph 700 are reversed. That is, in the aggregate result 600, when the average degree of relative importance of indices A vs. B is “-1”, the value model generation unit 301 connects the nodes A and B to generate an edge AB indicating the direction from node A to node B.

The edge AB is given the absolute value “1” of the average degree of relative importance of the index pair 601 (indices A vs. B). Similarly, the value model generation unit 301 generates edges BC and AC. The edges BC and AC are given the absolute value “1” of the average degrees of relative importance of the index pair 602 (indices B vs. C) and the index pair 603 (indices A vs. C). In this way, the preference graph 800 is generated.

As shown in FIGS. 7 and 8, the values assigned to the edges AB, BC, and AC are the absolute values of the average degrees of relative importance, and their directions are determined by the sign of the average degree of relative importance in the aggregate result 600.

Returning to FIG. 4, the probability transition graph conversion process (step S404) is a process in which the value model generation unit 301 converts the preference graph generated in the preference relationship graph structuring process (step S403) into a probability transition graph. Specifically, for example, the value model generation unit 301 normalizes the average degrees of relative importance given to the edges of the preference graph.

### Probability Transition Graph Conversion

FIG. 9 is an explanatory diagram showing an example of probability transition graph conversion from a preference graph. In FIG. 9, the node B will be focused on for description. The edge AB of the preference graph 901 is an edge that indicates the direction from node B to node A, and is given the absolute value “1” of the average degree of relative importance of indices A vs. B (whose average degree of relative importance is “1”). The edge BC of the preference graph 901 is an edge that indicates the direction from node B to node C, and is given the absolute value “2” of the average degree of relative importance of indices B vs. C (whose average degree of relative importance is “-2”).

In the probability transition graph conversion process (step S404), focusing on node B, normalization is performed so that the sum of the values of edges output from node B becomes “1”. An edge output from node B is a node indicating a direction from node B (starting node) to its destination node (terminating node), and corresponds to the edges AB and BC of the preference graph 901.

The value model generation unit 301 normalizes the values “1” and “2” given to the edges AB and BC of the preference graph 901 so that the value of the edge AB is changed from “1” to “0.33” (=1/(1+2)) and the value of the edge BC is changed from “2” to “0.66” (=2/(1+2)). The value model generation unit 301 performs such normalization on all nodes of the preference graph. The preference graph 901 after normalization is referred to as a value graph 902.

Returning to FIG. 4, the eigenvalue calculation process (step S405) is a process in which the value model generation unit 301 calculates eigenvalues from the value graph and calculates eigenvectors indicating the degree of preference. Specifically, for example, the value model generation unit 301 uses the PageRank method and the power method, which are general ranking algorithms, as methods for calculating eigenvalues and eigenvectors.

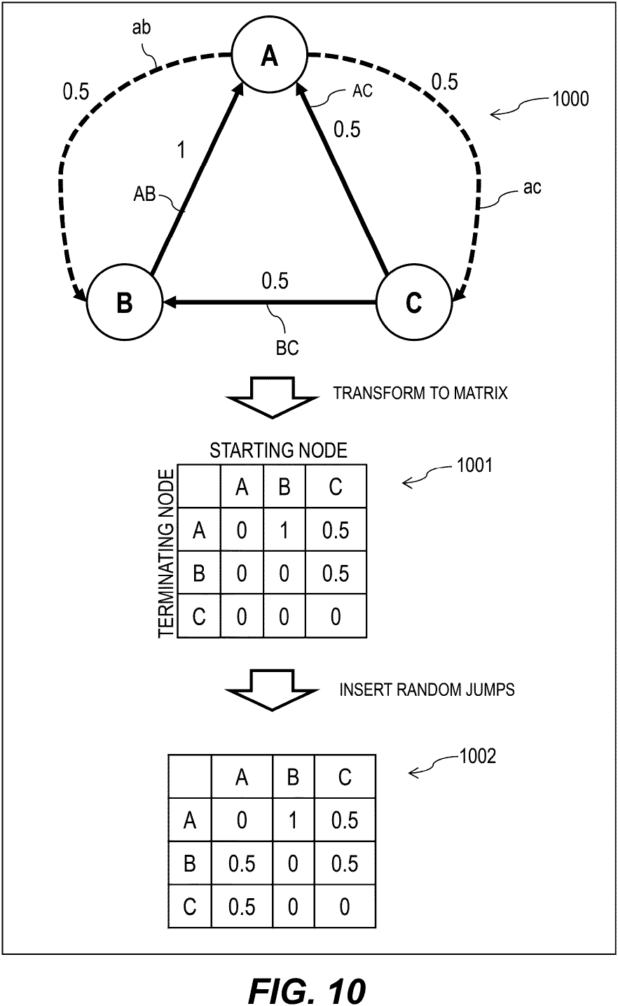

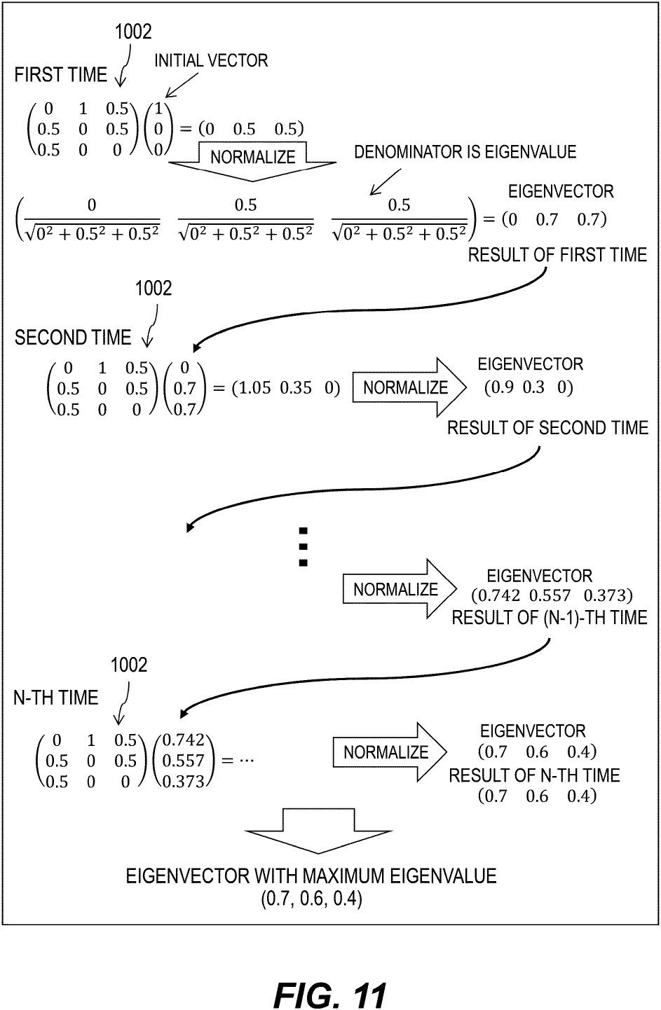

In the power method algorithm, the value model generation unit 301 treats the probability transition graph with the index number N as an N×N probability transition matrix to calculate eigenvalues and eigenvectors. For example, when the index number is 3 and the indices are A to C, it can be expressed as a 3×3 probability transition matrix, and the three rows and three columns correspond to the indices A to C, respectively. Calculation examples of eigenvalues and eigenvectors will be described with reference to FIGS. 10 and 11.

### Calculation of Eigenvalues and Eigenvectors

FIG. 10 is an explanatory diagram showing an example (first half) of calculating eigenvalues and eigenvectors in the eigenvalue calculation process (step S405), and FIG. 11 is an explanatory diagram showing an example (second half) of calculating eigenvalues and eigenvectors in the eigenvalue calculation process (step S405). In FIG. 10, the values of the edges AB, BC, and AC of the value graph 1000 are transformed into a matrix. The transformed matrix is referred to as a transition probability matrix 1001.

In the transition probability matrix 1001, the row direction is the starting node and the column direction is the terminating node. For example, the element “1” in row A and column B indicates the absolute value of the average degree of relative importance of the edge AB from node B to node A (that is, the average degree of relative importance of index A vs. B is “1”).

Next, in the value graph 1000, the value model generation unit 301 gives a hidden edge that transitions from a node such as node A that is not connected to the starting end side of the edge to all destination nodes with equal probability. Adding hidden edges (so-called random jumps) is performed by a convergence-enhancing algorithm used in the PageRank method. In the example of FIG. 10, a hidden edge ab from node A to node B and a hidden edge ac from node A to node C are added to the value graph 1000.

Hidden edges ab and ac are edges that transition to nodes B and C with equal probability, and the sum of the value of hidden edge ab and the value of hidden edge ac is “1” by normalization. Therefore, the values of the hidden edges ab and ac are each “0.5”. A transition probability matrix 1002 is a transition probability matrix 1001 to which hidden edges ab and ac are added.

Next, the value model generation unit 301 calculates eigenvalues and eigenvectors using the transition probability matrix 1002. Specifically, for example, as shown in FIG. 11, the i-th eigenvector is calculated by multiplying and normalizing the transition probability matrix 1002 and the eigenvector calculated at the (i-1)-th time (i is an integer that satisfies 1≤i≤N, N is an integer greater than or equal to 1, but the initial vector at the first time (i = 1) is (1, 0, 0)).

The value model generation unit 301 repeats this calculation N times. Since the vector obtained by multiplying the transition probability matrix 1002 and the eigenvector calculated at the (i-1)-th time is normalized, the maximum eigenvalue is “1”. The value model generation unit 301 adopts an eigenvector whose eigenvalue becomes the maximum value “1” as a result of N trials.

In FIG. 11, the N-th eigenvector (0.7, 0.6, 0.4) is the eigenvector with the maximum eigenvalue. The higher the value of the element in the eigenvector, the more important the node, or the index. Note that the eigenvalue may not be “1” but may be the maximum eigenvalue among the N trials. The eigenvector with the largest eigenvalue that is greater than or equal to a threshold (for example, 0.9) among the N trials may be adopted.

In this way, the value model generation unit 301 outputs the value graph 1000 and the eigenvector as value information. Next, the policy importance model generation unit 302 will be described.

### Policy Importance Generation Process

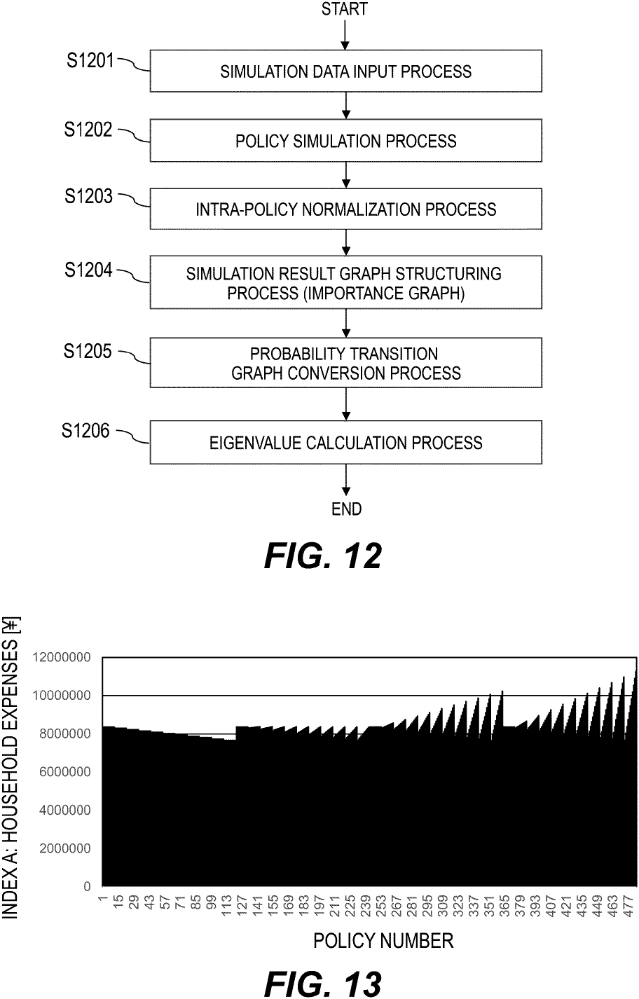

FIG. 12 is a flowchart showing an example of a policy importance generation processing procedure by the policy importance model generation unit 302. The policy importance model generation unit 302 estimates the fluctuation of each index for a plurality of policies regarding a target business through the policy simulation. Specifically, for example, the policy importance model generation unit 302 executes a process of converting the fluctuation of each index for each policy into information that can be compared with the value graph and the eigenvector.

That is, the policy importance model generation unit 302 performs a simulation data input process (step S1201) and a policy simulation process (step S1202) by a policy simulation processing unit 321, and an intra-policy normalization process (step S1203), a simulation result graph structuring process (step S1204), a probability transition graph conversion process (step S1205), and an eigenvalue calculation process (step S1206) by an importance modeling processing unit 322.

The simulation data input process (step S1201) is a process in which the policy importance model generation unit 302 receives input of simulation data. In policy simulations, simulation data includes, for example, data necessary for policy simulation such as, for example, the amount of solar radiation used to predict the amount of power generated by power generation facilities, the time-series data of power consumption used to predict household electricity demand, the purchase price of power generation facilities (for example, the price of solar panels), or the electricity rate of the business operator B.

The simulation data is stored in the database 104 and can be read by the policy decision support apparatus 103. In addition, the policy importance model generation unit 302, for example, acquires measurement data from various sensors such as a current measurement sensor such as a clamp meter and a pyranometer sensor installed in the target area as simulation data via the network 105. Furthermore, the policy importance model generation unit 302 may acquire open data managed by a public institution as simulation data via the network 105.

The policy simulation process (step S1202) is a process in which the policy importance model generation unit 302 calculates transactions of electric energy and money among the business operator B, the construction company of the power generation facilities, and the household users by the policy simulation and outputs the simulation results as indices. As the policy simulation, for example, an agent-based simulation is used. Agent-based simulation is a process of calculating an index, which is a simulation result, for a parameter set by changing a predetermined parameter. Since the agent-based simulation itself is an existing simulation, the details are omitted.

This parameter set corresponds to each policy. In the first embodiment, the parameters of the parameter set include, for example, the ratio of users of the business operator B (a parameter indicating how many households out of 100 households have a contract with the business operator B) and the scale (system capacity of a solar panel) when the photovoltaic power generation facilities are installed in the household using the business operator B. The policy importance model generation unit 302 executes a policy simulation using 484 combinations of parameters. That is, there are 484 policies, and a plurality of (three in this example) indices A to C are output for each policy.

### Simulation Results of Each Index

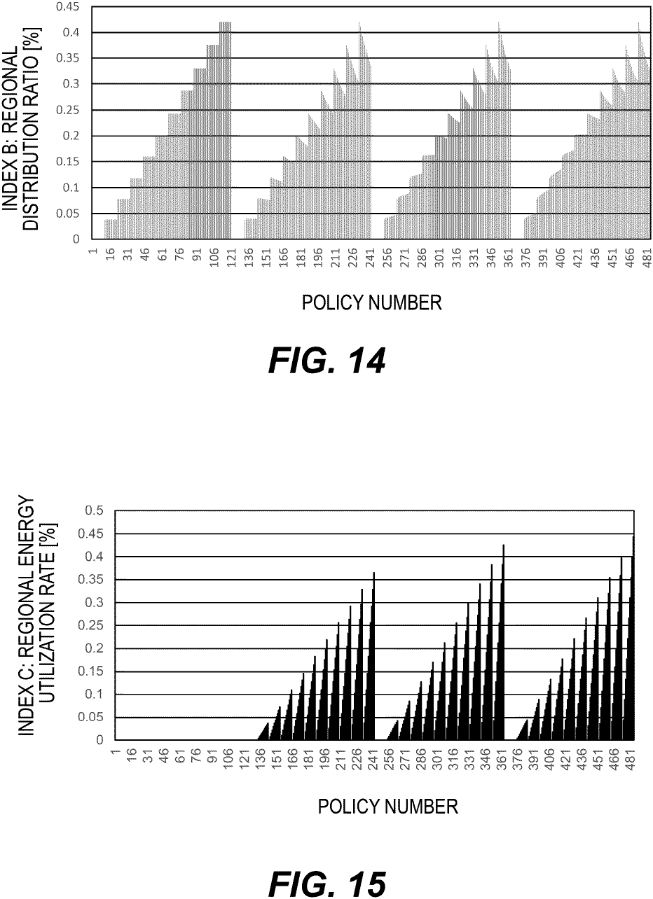

FIG. 13 is a graph showing an example of simulation results of index A for each of the 484 policies. FIG. 14 is a graph showing an example of simulation results of index B for each of the 484 policies. FIG. 15 is a graph showing an example of simulation results of index C for each of the 484 policies. In FIGS. 13 to 15, the horizontal axis indicates policy numbers 1 to 484, and the vertical axis indicates the values of respective indices A to C.

Returning to FIG. 12, the intra-policy normalization process (step S1203) is a process in which the policy importance model generation unit 302 performs normalization to enable comparison between indices when the units differ between indices. Specifically, for example, the unit of index A is [yen], but the unit of the indices B and C is [%]. The policy importance model generation unit 302 first determines in advance a policy that serves as a reference. The policy that serves as a reference is referred to as a “reference policy”.

The method of determining the reference policy includes, for example, a method of setting the state closest to the present, and a method of setting the reference policy in advance by an evaluator, in this example, the municipal entity M or the business operator B, before executing the policy simulation. In the first embodiment, the policy number 1 is taken as the reference policy, and the reference policy is taken as a policy indicating a state in which the number of users of renewable energy and the business operator B is zero.

Next, the policy importance model generation unit 302 determines the reference increase/decrease direction for each of the indices A to C. The reference increase/decrease direction is, for example, the direction in which the index (simulation result) is improved. Specifically, for example, the reference increase/decrease direction is the direction in which the household expenses decrease for the case of index A, the direction in which the regional distribution rate increases for the case of index B, and the direction in which the regional energy utilization rate increases for the case of index C.

The increase/decrease direction is an item that is set so that the values of increase/decrease can be compared when comparing the amounts of change of each of the indices A to C from the reference policy. In the setting of the indices A to C, a decrease of index A and an increase of index B and index C as compared with the reference policy are treated similarly (both are treated as improving in the same way). The reference increase/decrease method may be set in advance before execution of the policy simulation, and may be changed for each policy simulation.

Next, the policy importance model generation unit 302 calculates the difference between the policy results of the plurality of policy simulations (484 policies in the first embodiment) and the policy results of the reference policy according to the reference increase/decrease direction for each of the indices A to C.

If the reference increase/decrease direction is negative (decrease), for example, the difference is calculated as follows for index A.

Difference = (value of index A of reference policy) - (value of index A of policy)

If the reference increase/decrease direction is positive (increase), for example, the difference is calculated as follows for index A.

Difference = (value of index A of policy) - (value of index A of reference policy) Therefore, the value of the difference is calculated for the number of policies for each of the indices A to C, with the reference policy set to 0.

Next, the policy importance model generation unit 302 calculates the maximum value and the minimum value of this difference for each of the indices A to C. The policy importance model generation unit 302 executes normalization of each of the indices A to C according to a pseudocode 1600 of the intra-policy normalization process.

### Pseudocode

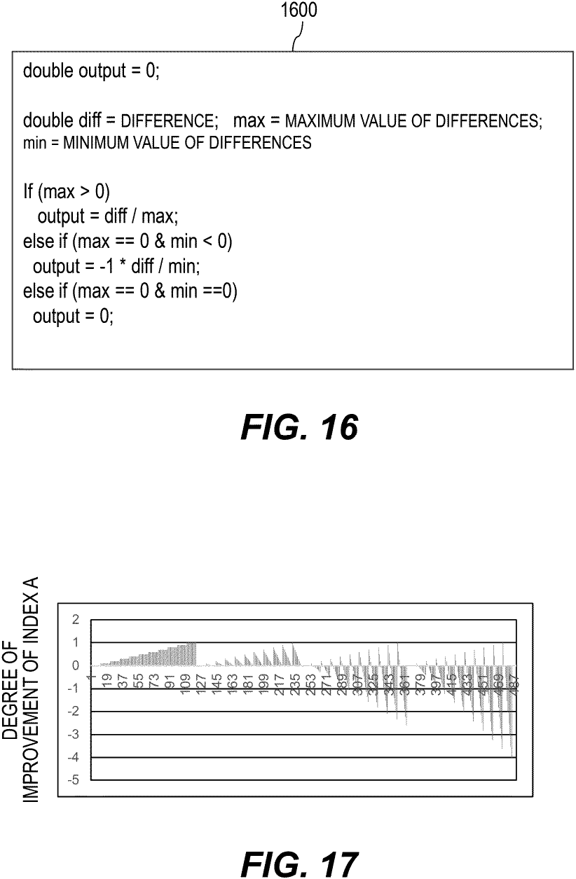

FIG. 16 is an explanatory diagram showing an example of pseudocode for a given index. In the pseudocode 1600, “output” indicates the output value after normalization, “diff” indicates the difference described above, “max” indicates the maximum value of the difference, and “min” indicates the minimum value of the difference. In this way, the policy importance model generation unit 302 can normalize the indices A to C so that 0 is assigned to the reference policy, 1 is assigned to the best policy for the increase/decrease specified in the reference increase/decrease direction, and a negative value is assigned to policies in the direction opposite to the direction specified in the reference increase/decrease direction. That is, the value range after normalization is +1 to -∞. Moreover, the value after this normalization is referred to as a “degree of improvement” in the first embodiment.

### Degree of Improvement

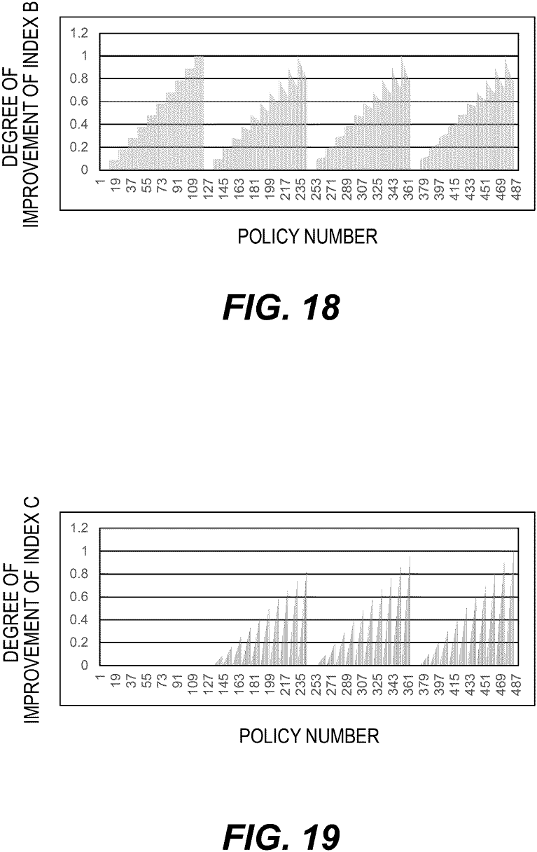

FIG. 17 is a graph showing the degree of improvement for each policy of the index A in the result of the policy simulation shown in FIG. 13. FIG. 18 is a graph showing the degree of improvement for each policy of the index B in the result of the policy simulation shown in FIG. 14. FIG. 19 is a graph showing the degree of improvement for each policy of the index C in the result of the policy simulation shown in FIG. 15. In FIGS. 17 to 19, the reference policy is the policy with policy number 1. In FIG. 17, the index A is normalized with the reference increase/decrease direction as the decreasing direction, and the maximum value is 1. In FIG. 18, the index B is normalized with the reference increase/decrease direction as the increasing direction, and the maximum value is 1. The index C is normalized with the reference increase/decrease direction as the increasing direction, and the maximum value is 1.

Returning to FIG. 12, the simulation result graph structuring process (step S1204) is a process in which the policy importance model generation unit 302 performs normalization to enable comparison between indices when the units differ between indices. Specifically, for example, the policy importance model generation unit 302 generates an importance graph from the simulation result. Here, the policy with policy number 112 will be described as an example.

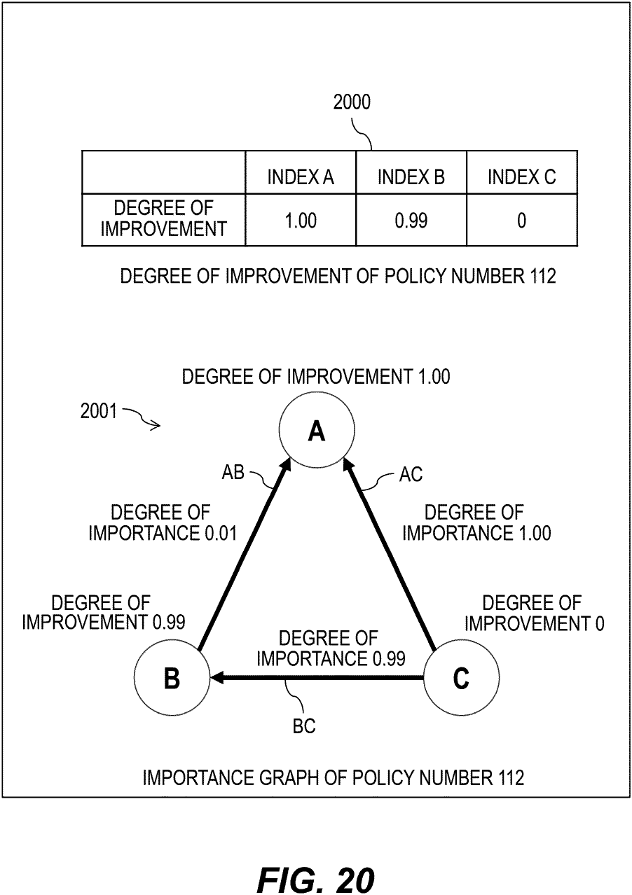

FIG. 20 is an explanatory diagram showing an example of the improvement information of the policy with the policy number 112 and the graph structuring process. The improvement information 2000 is a simulation result indicating the degree of improvement for each of the indices A to C. The policy importance model generation unit 302 generates the importance graph of the policy with the policy number 112 by the graph structuring process using the improvement information 2000. The importance graph 2001 uses the indices A to C as nodes A to C, uses the difference between the degrees of improvement of two of the nodes A to C as the degree of importance, and generates edges AB, BC, and AC starting from a node with the smaller degree of improvement as the starting point and terminating at a node with the larger degree of improvement as the terminating point.

For example, in the improvement information 2000, the degree of improvement of node A is 1.00 and the degree of improvement of node B is 0.99. Therefore, the degree of importance between nodes A and B is obtained as follows.

$$\left|1.00 - 0.99\right| = 0.01$$

The degree of importance is an absolute value and is a numerical value of 0 or more. Since the degree of improvement of node A is larger than the degree of improvement of node B, an edge AB starting from node B as the starting point and terminating at node A as a terminating point is generated. The policy importance model generation unit 302 executes such processing for all combinations of nodes to generate edges BC and AC. When the degree of importance is 0, no edge is generated.

Although FIG. 20 illustrates an example of generating the importance graph for the policy with the policy number 112, the importance graphs for policies with other policy numbers are generated in the same manner. Since there are 484 policies in the first embodiment, 484 importance graphs are generated.

Returning to FIG. 12, the probability transition graph conversion process (step S1205) is the same process as the probability transition graph conversion process (step S404 in FIG. 9) by the value model generation unit 301. In this process, the policy importance model generation unit 302 performs normalization with the importance graph as an input so that the sum of the outputs of the nodes A to C is 1 for the degrees of importance of the edges AB, BC, and AC.

The eigenvalue calculation process (step S1206) is the same process as the eigenvalue calculation process (step S405 in FIGS. 10 and 11) by the value model generation unit 301. In this process, the policy importance model generation unit 302 calculates eigenvalues and eigenvectors with the importance graph normalized by the probability transition graph conversion process (step S1205) as an input. In the first embodiment, since there are 484 importance graphs, 484 eigenvectors are calculated.

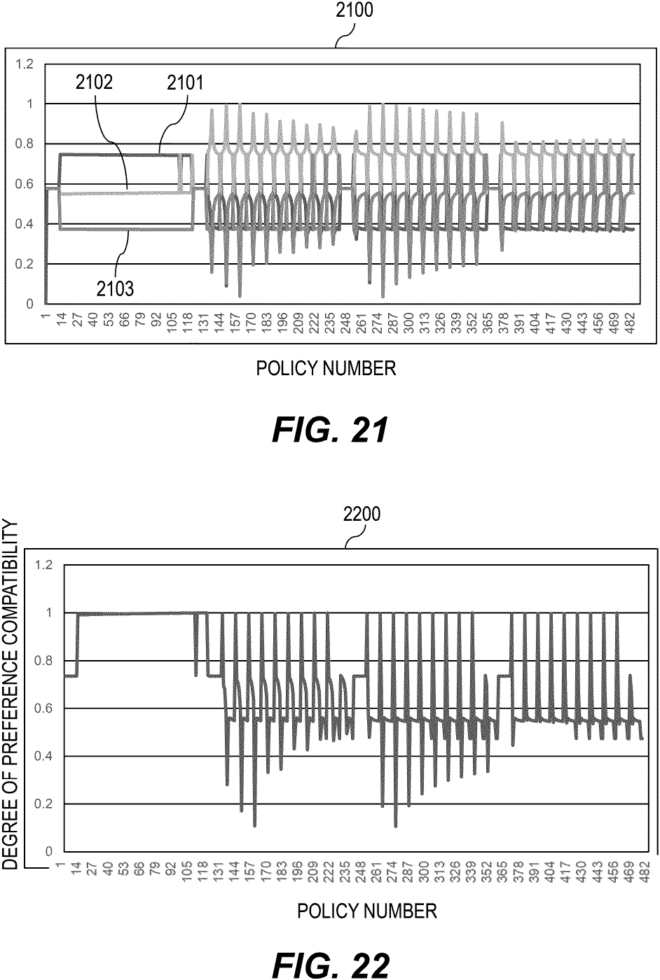

FIG. 21 is a graph showing the calculation results of the eigenvectors of each policy in the first embodiment. The policy importance model generation unit 302 outputs one or more importance graphs and eigenvectors as importance information. In the first embodiment, 484 importance graphs and eigenvectors are output. The horizontal axis of the graph 2100 is the policy number, and the vertical axis is the element of the eigenvector.

A waveform 2101 is a waveform obtained by plotting the elements of the eigenvector corresponding to the index A for each policy. A waveform 2102 is a waveform obtained by plotting the elements of the eigenvector corresponding to the index B for each policy. A waveform 2103 is a waveform obtained by plotting the elements of the eigenvector corresponding to the index C for each policy.

Further, when the number of policies increases, the number of importance graphs to be calculated also increases in proportion. Furthermore, when the reference policy is changed or when the reference increase/decrease direction is changed, the importance level modeling processing unit 322 needs to repeatedly execute the intra-policy normalization process (step S1203), the simulation result graph structuring process (step S1204), the probability transition graph conversion process (step S1205), and the eigenvalue calculation process (step S1206), which increases the amount of calculation. That is, when the reference policy is changed, it is necessary to recalculate the degree of improvement, the degree of importance, and the eigenvalues.

For example, the eigenvalue calculation requires N×N matrix operations for the graph structure of N indices when using the power method algorithm. If such eigenvalue calculation is repeated for a plurality of policies each time the reference increase/decrease direction is changed, the amount of calculation becomes enormous. Therefore, in the first embodiment, in order to reduce the amount of calculation due to repetition of the simulation result graph structuring process (step S1204), the policy importance model generation unit 302 groups the graphs using the degree of improvement.

Since the degree of improvement is calculated between the reference policy and each policy, even if the reference policy changes, it does not greatly affect the relationship between the policies. In the iterative calculation of the simulation result graph structuring process (step S1204), in the first process, the policy importance model generation unit 302 first determines an arbitrary reference policy and calculates, for all policies, the degree of improvement and the degree of importance corresponding to each policy.

After that, the policy importance model generation unit 302 calculates the degree of similarity between policies according to the degree of improvement. Since the degree of improvement has as many dimensions as the number of indices for each policy, for example, the degree of similarity between policies is calculated by the sum of squared differences. For example, when there are policies 1 and 2, the policy importance model generation unit 302 calculates the sum of the squared differences between the degrees of improvement of the indices A to C of the policy 1 and the degrees of improvement of the indices A to C of the policy 2.

Then, the policy importance model generation unit 302 groups the policies whose degrees of similarity are equal to or lower than a certain threshold. For example, if the degree of similarity between policies 1 and 2 is equal to or less than the threshold, the policy importance model generation unit 302 determines the policy 1 as a representative policy and the policy 2 as a sub-policy of the representative policy. Here, the policy with the smaller policy number is taken as the representative policy, but either one may be taken as the representative policy. On the other hand, when the degree of similarity is greater than the threshold, the policy importance model generation unit 302 determines both policies 1 and 2 as representative policies.

Similarly, the policy importance model generation unit 302 calculates the degrees of similarity between the policy 1 and the policies 3 to n, and calculates sub-policies with the policy 1 as the representative policy. Next, the policy importance model generation unit 302 searches for sub-policies using each of the other policies that are not sub-policies of the policy 1 as representative policies. In this way, the policy importance model generation unit 302 groups policies and determines representative policies.

In the iterative calculation of the simulation result graph structuring process (step S1204), in the second process, the policy importance model generation unit 302 executes the calculation of the degree of improvement and the degree of importance for the representative policy, thereby reducing the calculation amount. Further, setting the threshold of the degree of similarity more strictly increases the amount of calculation, but on the other hand, a large number of representative policies are set, and detailed evaluation becomes possible. On the other hand, if the threshold of the degree of similarity is set more loosely, the amount of calculation can be greatly reduced.

Another method of reducing the amount of calculation will be described. In the eigenvalue calculation process (step S1206), the PageRank method, which is a kind of ranking algorithm, is used. There is also a concern that the calculation of the PageRank method will be processed in large numbers due to the number of policies and repetition of graph calculations. Therefore, in the eigenvalue calculation processing (step S1206) according to another calculation amount reduction method, instead of calculating the eigenvalues of one large graph, the policy importance model generation unit 302 calculates eigenvalues for a large number of similar graphs (graphs with the same number of vertices and meaning (indices) of vertices).

The PageRank method is a calculation method in which a certain initial value is given and then the calculation is converged by iterative calculations, and has the characteristic that the amount of calculation varies depending on how the initial value is given. Therefore, since the eigenvalue calculation process (step S1206) according to another calculation amount reducing method has the feature of calculating a large number of similar graphs as described above, the amount of calculation (number of iterations) can be reduced by selecting the initial value using the calculated eigenvalues and eigenvectors.

Returning to FIG. 3, the comparative quantification processing unit 303 will be described. A value graph and eigenvectors (hereinafter referred to as value eigenvectors) are output as value information from the value model generation unit 301. One or more importance graphs and eigenvectors (hereinafter referred to as importance eigenvectors) are output as policy importance information from the policy importance model generation unit 302.

The comparative quantification processing unit 303 calculates the vector distances between the value eigenvectors and the importance eigenvectors. As the vector distance, the Euclidean distance is used, for example. Here, the value eigenvector xV is defined as xV=(xVA, xVB, xVC), and the importance eigenvector xSj of policy number j is defined as xSj=(xSAj, xSBj, xSCj).

The Euclidean distance D in this case is calculated as follows.

$$\text{D=} √ \left[{\left(\text{xVA-xSAj}\right)}^{2} + {\left(\text{xVB-xSBj}\right)}^{2} + {\left(\text{xVC-xSCj}\right)}^{2}\right]$$

The smaller D is, the higher the degree of similarity between the value eigenvector xVand the importance eigenvector xSj of policy number j. In addition, the degree of preference compatibility F (≤1) is defined as follows.

$$\text{F=1-D}$$

FIG. 22 is a graph showing the degree of preference compatibility F of each policy. In the graph 2200, the horizontal axis indicates the policy number j, and the vertical axis indicates the degree of preference compatibility F. The degree of preference compatibility F mainly quantitatively indicates the degree of matching between the preference order of values and the improvement order of the degree of importance. However, although the degree of preference compatibility F is an evaluation value for evaluating the order, it is not suitable for evaluating an absolute value. Therefore, next, the comparative quantification processing unit 303 calculates the average value of the degrees of improvement, which are the values of the nodes A to C in the importance graph 2001, for each policy j. The average value of the degrees of improvement is referred to as an average degree of improvement.

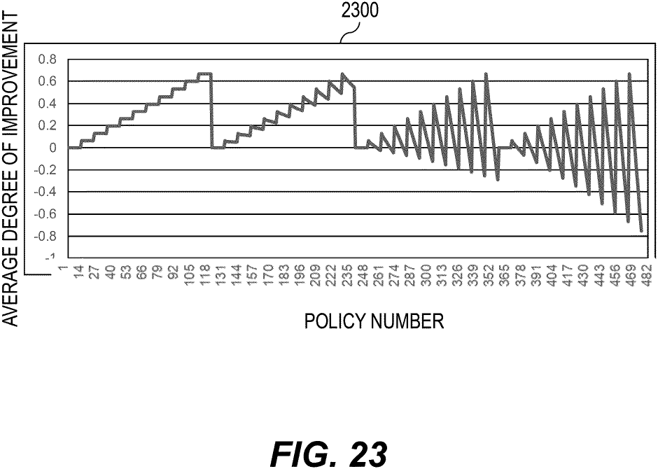

FIG. 23 is a graph showing the average degree of improvement of each policy. In the graph 2300, the horizontal axis indicates the policy number j, and the vertical axis indicates the average degree of improvement. The average degree of improvement is the average value of the degrees of improvement for the three representative indices A to C. The comparative quantification processing unit 303 adds the degree of preference compatibility F and the average degree of improvement for each policy. The added value is referred to as the degree of matching with the resident R’s values.

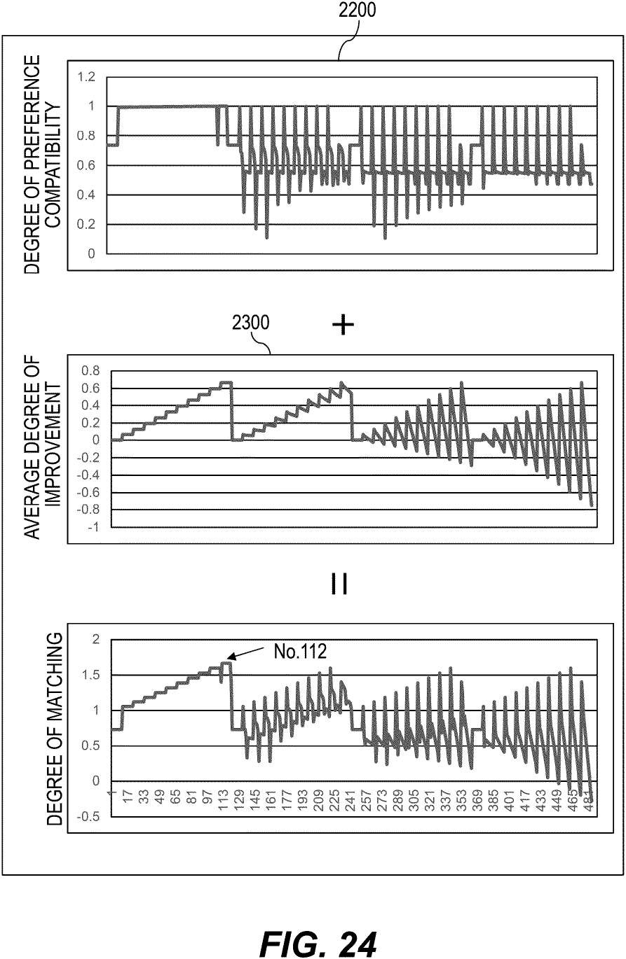

FIG. 24 is an explanatory diagram showing an example of calculation of the matching degree of each policy. In FIG. 24, for policy number 1, for example, the sum of the degree of preference compatibility F of policy number 1 and the average degree of improvement TP is the matching degree of policy number 1. Similarly, the same addition operation is applied to policy numbers 2 to 484. The comparative quantification processing unit 303 outputs the degree of matching of each policy in addition to the value information output from the value model generation unit 301 and the policy importance information output from the policy importance model generation unit 302. The degree of matching thus obtained indicates the degree of matching of values with respect to policies developed by the business operator B, and quantitatively indicates the social value of the business. The policy with the highest degree of matching is the most compatible with the values to be measured.

As shown in FIG. 24, the policy with the highest degree of matching is policy number 112. This addition result is displayed on the first information terminal 101 for the municipal entity M and the business operator B. In this way, it is possible to contribute to policy examination. The second information terminal 102 of the municipal entity M displays the ranking of the maximum policy and the degree of matching. In this way, the municipal entity M can examine policies while quantitatively grasping the degree of matching of the values of the residents R.

In this way, the policy decision support system 100 according to the first embodiment can predict the impact of business or the like on the social, environmental, and economic value axes and quantify social values in activities to improve values, that is, quantify the degree of matching (equivalent to social acceptability or the like) between the business and the residents R’s values.

### Second Embodiment

A second embodiment will be described. The second embodiment is an example in which machine learning is introduced into the value acquisition process (step S401) and the statistical processing on the acquired data (step S402) by the value model generation unit 301 in the policy decision support system 100 of the first embodiment. In the second embodiment, machine learning is used to predict the preference relationship and reduce the number of questions asked to the resident R in order to deal with an increase in the number of indices. In addition, in the second embodiment, since the description will focus on the differences from the first embodiment, the description of the parts common with the first embodiment will be omitted.

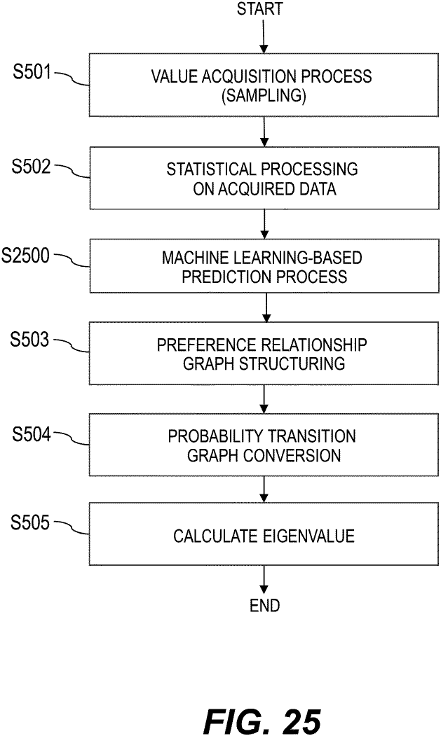

FIG. 25 is a flowchart showing an example of a value model generation processing procedure when using a neural network. In the second embodiment, a machine learning-based prediction process (step S2500) will be described after the statistical processing on acquired data (step S502). A machine learning device receives feature amount vectors of two indices as input, and predicts a preference relationship between indices, here, a response result. In the second embodiment, the response result to be predicted is not the response of one respondent but the response result after aggregation. For example, if there are three indices (A to C), the feature amount vector of index A indicates feature amounts related to household, expense, economy, and the like.

Specifically, for example, when an index is represented by a one-hot vector with feature amounts related to household, expense, and economy, for example, if the index is an index related to “household”, the index is represented by a vector (1, 0, 0) in which the corresponding component is “1” and the other components are “0”. Similarly, if the index is related to “cost”, the index represented by a vector (0, 1, 0) in which the corresponding component is “1” and the other components are “0”. If the index is related to “economy”, the index is represented by a vector (0, 0, 1) in which the corresponding component is “1” and the other components are “0”.

In addition, depending on the method of coding, for example, an index related to “household” may be represented as a vector component of “0”, an index related to “whole region” may be represented as a vector component of “1”, and an index related to “local company” may be represented as a vector component of “2”.

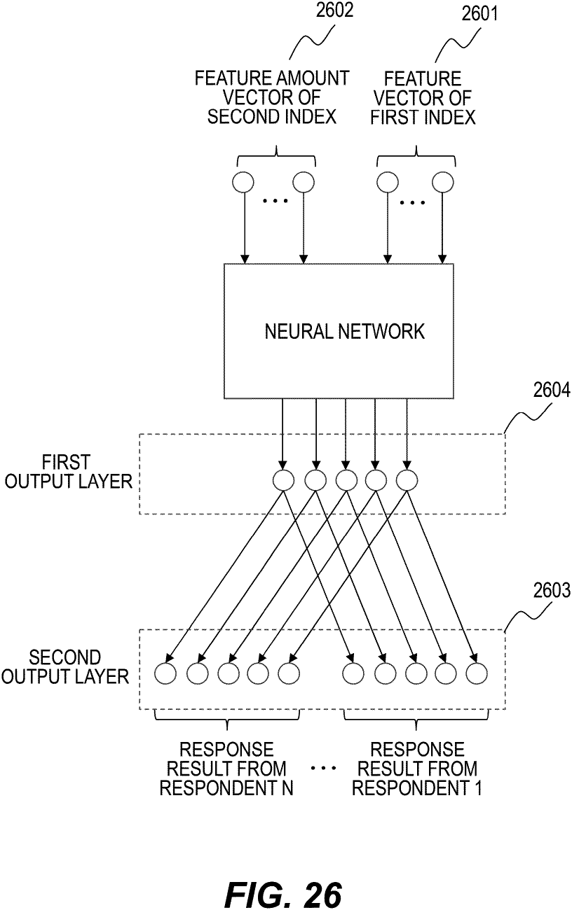

FIG. 26 is an explanatory diagram showing a structural diagram of a neural network. The policy importance model generation unit 302 inputs a feature amount vector 2601 related to the first index (for example, index A) and a feature amount vector 2602 related to the second index (for example, index B) to the machine learning device. The teacher data for the machine learning device is the response results of the questionnaire for the residents R.

Teacher data is input from a second output layer 2603. In the example of FIG. 26, the question for the respondent is a five-point scale. In this way, the response result is 5 vectors corresponding to the responses from each respondent. The selected vector is set to “1” and the others are set to “0”. If there are N respondents, the response results of the respective respondents are used as teacher data. After that, the policy importance model generation unit 302 uses the feature amount vectors 2601 and 2602 and the teacher data (response results) to execute the learning process of the internal neural network by the error backpropagation method. In this way, a machine learning device is generated.

A first output layer 2604 is used in the identification process after the learning process, that is, in the preference relationship prediction process. For example, when the feature amount vector 2601 of the index A and the feature amount vector 2602 of the index B are input to the neural network (machine learning device) after the learning process is finished with the combination of the index A and the index B, the same values as the statistical processing on the response results of the respondents (for example, when the questionnaire results of “-2 to +2” in the 5-point scale are collected, a process of totaling such that “+2” is xx%, “+1” is yy%, and so on) are output to the first output layer 2604.

The number of dimensions of the first output layer 2604 is 5 if the questionnaire question is a five-point scale. By using a machine learning device, when a feature amount vector of index A′ having a feature amount vector similar to that of index A and a feature amount vector of index B are input, the prediction results of the preference relationship is output to the first output layer 2604. This has the effect of reducing the number of questions by sampling the number of questions in advance, providing the questions to the residents R, predicting responses to unknown questions based on the response results. As another method, using a machine learning device that has already been trained on other survey subjects is also effective in reducing the number of questions. According to the second embodiment, it is possible to reduce the number of questions compared to the policy decision support system 100 of the first embodiment.

### Third Embodiment

A third embodiment shows a display example of the second information terminal 102 of the municipal entity M and the business operator B in the policy decision support system 100 of the first embodiment. In the first embodiment, the second information terminals 102 of the municipal entity M and the business operator B displays the policy with the maximum degree of matching and the ranking of the degree of matching. On the other hand, in order to examine the validity of the result, the municipal entity M and the business operator B may need to evaluate the value graph and the importance graph that are the basis for calculating the matching degree.

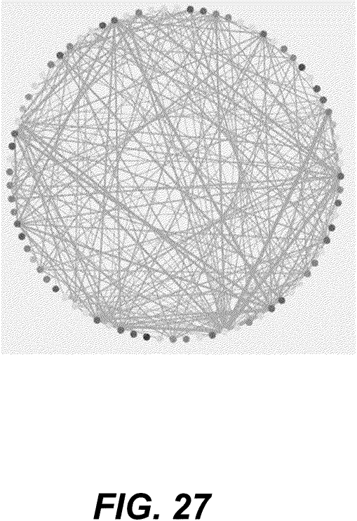

FIG. 27 is an explanatory diagram showing a display example of the value graph or the importance graph. In FIG. 27, the points arranged on the ring are nodes (corresponding to indices), and the edges between the nodes are drawn inside the ring. As an example of displaying nodes, the display color of a node may be changed according to the attribute held by the node, such as an index belonging to social value, an index belonging to environmental value, or an index belonging to economic value (for example, orange for social value, green for environmental value, blue for economic value, and mixed color for a node having a plurality of attributes), and the shade and size of the node may be changed according to the value held by the node (the degree of improvement in the case of an importance graph).

In addition, the edges in the ring are displayed while changing the thickness according to the magnitude of the value of the statistical data of the response result, which is the aggregate result of the questionnaire for values in the case of the value graph, and the magnitude of the value of the degree of importance in the case of the importance graph. The display method can be changed by setting. With such display, it is possible to intuitively grasp a complicated graph, and, for example, compare two graphs (value graph and importance graph) and subjectively evaluate the degree of matching.

### Fourth Embodiment

A fourth embodiment will describe a case where, in the simulation data input process (step S1201) of the policy importance model generation unit 302 in the first embodiment, the simulation data is input by experts in a workshop or the like. In the first embodiment, an example of agent-based simulation has been described in the policy simulation process (step S1202). Agent-based simulation requires models of agents (household agents, power plant agents, and business operator agents in the example of the first embodiment). In the first embodiment, the flow of electric power and the flow of money are described in the model. However, there are cases where it is difficult to prepare such models. In such cases, a system dynamics model is applied as an alternative to agent-based simulation. System dynamics is a numerical simulation developed for use in the dynamic analysis of systems in the fields of business administration and social sciences.

System dynamics models the dependency related to increase/decrease between index groups. For example, if the index of the electricity rate of business operator B is increased, the index of household expenses will increase. A dependency model modeled in this way is a system dynamics model.

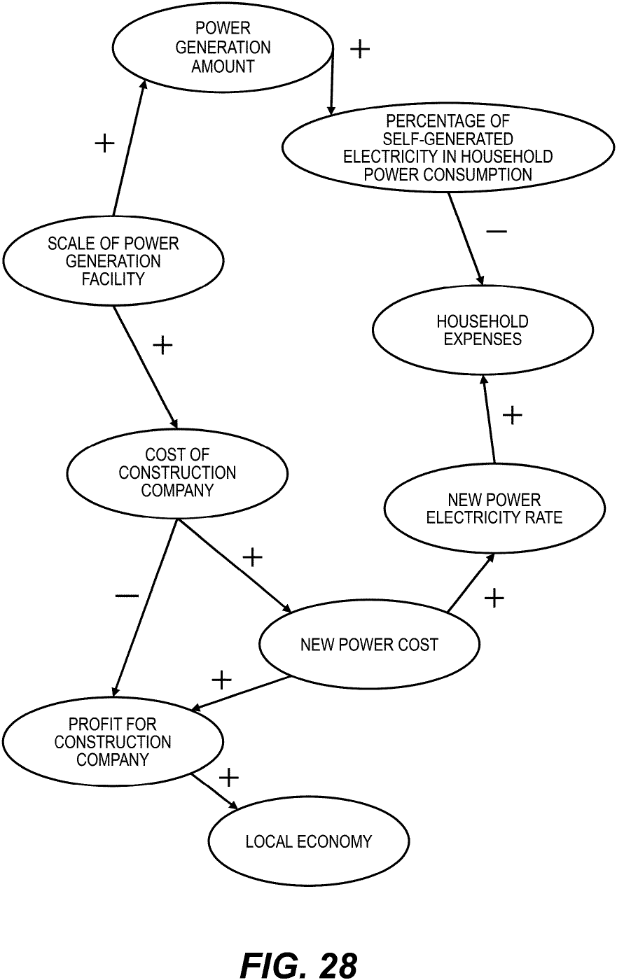

FIG. 28 is an explanatory diagram of a dependency model between indices based on the example of the first embodiment. FIG. 28 shows a portion of the dependency model. In FIG. 28, elliptical nodes indicate indices. An edge indicates an increase/decrease relationship between nodes, a notation “+” shows the relationship that if the quantity indicated by the starting node increases, the quantity indicated by the terminating node also increases, and a notation “-” shows the relationship that if the quantity indicated by the starting node increases, the quantity indicated by the terminating node decreases.

An increase width and a decrease width can also be set for each edge. For example, if the increase width of an edge is 0.5, and the increase of a starting node is 10%, the increase width of the terminating node is 5% (=10%×0.5). That is, the increase/decrease width can indicate the rate of transmission between nodes. By determining these edges by an expert or the like, it is possible to roughly model the dependency relationship between indices.

The policy decision support apparatus 103 executes a policy simulation on the system dynamics model. Specifically, for example, the policy decision support apparatus 103 executes a policy simulation to determine whether each index will increase or decrease when the scale of a power generation facility is increased. Then, the policy decision support apparatus 103 uses the obtained increase or decrease of each index as the degree of improvement in the first embodiment. In this way, subsequent processing can be performed in the same manner as in the first embodiment.

### Fifth Embodiment

In a fifth embodiment, a subject different from the first to fourth embodiments will be described as an example. The policy decision support apparatus 103 of the fifth embodiment uses safety and health awareness as a subject, and calculates the degree of matching between the values of employees of a certain organization and the policies to raise safety awareness in a situation where policies to raise safety awareness are examined. There is a high need for policies aimed at enlightenment, such as raising safety awareness, but in many cases, it is more important whether or not the target person, such as employees, will execute the policies rather than the effect of the policies themselves.

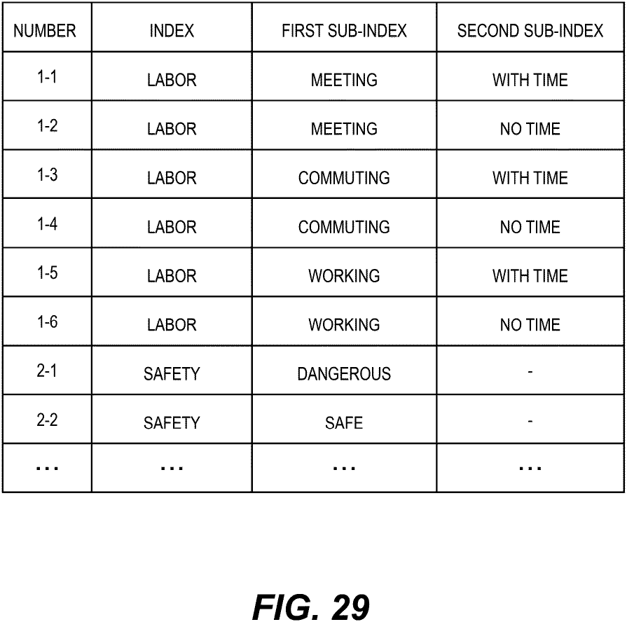

FIG. 29 is an explanatory diagram showing indices and sub-indices related to safety awareness. The indices include, for example, “labor (time)”, “safety”, “monetary cost”, and so on. An index is decomposed into zero or more sub-indices. This is because, for example, even if the index is “labor”, the degree of importance changes depending on the situation in which the worker is placed, such as working, meeting, or commuting.

The sub-indices differ depending on the index and are set in advance. If the first sub-index related to the index “labor” in FIG. 29 is “state”, it takes values of “working”, “meeting”, and “commuting”. If the second sub-index is “time allowance”, it takes values such as “with time”, “no time”, “before meeting (for example, how many minutes before)”, and “before deadline”. The value of a sub-index is assigned a predetermined integer, for example, working=0. When generating preference relationships between indices, separate indices are used due to different combinations of sub-indices. For example, “labor: state=working, time allowance=no time” and “labor: state=meeting, time allowance=no time” are treated as separate indices. Therefore, the policy decision support apparatus 103 determines the preference order between indices and which action is more important.

The value model generation unit 301 of the fifth embodiment acquires values through a questionnaire or the like, and calculates a value graph and eigenvectors, for example, as described in the first embodiment.

Next, the policy importance model generation unit 302 of the fifth embodiment targets the index group handled by the value graph. The policy importance model generation unit 302 estimates the degree of improvement of each index for policies by an expert or the like on safe behavior.

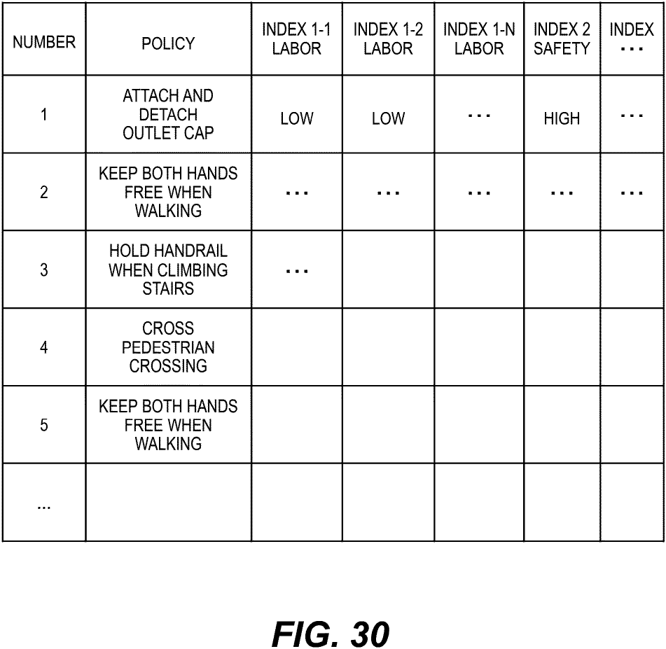

FIG. 30 is an explanatory diagram showing an example of policies regarding safety awareness. The policy decision support apparatus 103 estimates the improvement effect and the like of the index for each policy. Indices 1-1 to 1-n indicate combinations of sub-indices of index 1 (labor). The policy decision support apparatus 103 estimates the importance graph of each policy based on the degree of improvement. In the estimation of the importance graph, a node indicates an index group, an edge indicates a difference in the estimated degree of improvement, and a direction indicates a direction from a low degree of improvement to a high degree of improvement. After estimating the importance graph, the policy decision support apparatus 103 calculates eigenvectors in the same manner as in the first embodiment, and calculates the degree of matching using the value graph and the eigenvectors. In this way, it is possible to estimate the degree of matching between policies and the values of employees and the like.

Further, the policy decision support apparatus 103 according to the first to the fifth embodiments described above can also be configured as (1) to (13) below.

A policy decision support apparatus 103 includes a processor 201 that executes a program and a storage device 202 that stores the program, and supports policy decision based on a plurality of indices A to C. The processor 201 executes: a generation process of expressing the plurality of indices A to C as nodes A to C and expressing, for every two indices {(A, B), (B, C), (A, C)} among the plurality of indices A to C, superiority or inferiority between the two indices as an edge connecting the two nodes to generate a graph (a value graph 1000 or an importance graph) modeling a relationship between the plurality of indices A to C; and a calculation process of calculating an importance level of each of the plurality of indices A to C based on the graph generated in the generation process.

In this way, it is possible to construct a relationship in which the superiority or inferiority between each index and another index is ranked. Therefore, it is possible to quantify the relationships among the plurality of indices A to C.

In the policy decision support apparatus 103 according to (1), the processor 201 executes: an acquisition process of acquiring a degree of relative importance between the two indices based on responses from residents R within a target area of the policy (step S401), in the generation process, the processor 201 expresses the plurality of indices as nodes and expresses the degree of relative importance between the two indices as an edge connecting the two nodes to generate a value graph 1000 showing values of the residents R, modeling the degree of relative importance between the two indices (steps S402 to S404), and in the calculation process, the processor 201 calculates a degree of preference indicating a preference relationship of the plurality of indices as the importance level based on the value graph 1000 (step S405).

In this way, it is possible to construct a relationship in which the superiority or inferiority between each index and another index is ranked based on the degree of relative importance given by the resident R. Therefore, it is possible to quantify the preference relationships among the plurality of indices A to C.

In the policy decision support apparatus 103 according to (2), in the generation process, the processor 201 generates the value graph 1000 by inputting feature amount vectors corresponding to the two indices to a machine learning device that predicts the responses.

In this way, it is possible to predict the degree of preference and reduce the number of questions asked to the resident R.

In the policy decision support apparatus 103 according to (1), the processor executes an acquisition process of acquiring, for each of the indices, a degree of improvement of the policy based on a result of a simulation of the policy using a plurality of parameters in a target area of the policy (steps S1201 to S1203), in the generation process, the processor 201 expresses each of the plurality of indices A to C as nodes and expresses the degree of relative importance between the two indices {(A, B), (B, C), (A, C)} based on the degrees of improvement of the two indices {(A, B), (B, C), (A, C)} acquired in the acquisition process as an edge connecting the two nodes to generate an importance graph 2001 of the policy modeling a degree of relative importance between the two indices {(A, B), (B, C), (A, C)} (steps S1204 and S1205), and in the calculation process, the processor 201 calculates the degree of importance of each of the plurality of indices as the importance level based on the importance graph 2001.

In this way, it is possible to construct a relationship in which the superiority or inferiority between each index and another index is ranked based on the degree of relative importance given by the policy proposing party (the business operator B). Therefore, it is possible to quantify the relationship of which index is considered more important among the plurality of indices A to C.

In the policy decision support apparatus 103 according to (4), in the acquisition process, the processor 201 acquires, for each of the indices, the result of a simulation using the plurality of parameters for each of the plurality of policies, and acquires, for each of the indices, a degree of improvement of each policy by normalizing a difference between a result of a simulation of a reference policy among the plurality of policies and a result of a simulation of another policy based on the difference and a direction in which the result is improved, in the generation process, the processor 201 generates the importance graph 2001 for each of the policies, and in the calculation process, the processor 201 calculates the degree of importance of each of the plurality of indices A to C for each of the policies based on the importance graph 2001.

In this way, it is possible to align the units between the plurality of indices A to C, and to quantify the relationship between the plurality of indices A to C.

In the policy decision support apparatus 103 according to (4), in the acquisition process, the processor 201 acquires, for each of the indices, the degree of improvement of each of the plurality of policies, and groups policies having similar degrees of improvement of the policy for each of the indices into policy groups, in the generation process, the processor expresses a plurality of indices of a representative policy which is one of the policies in each of the policy groups as nodes and expresses a degree of relative importance between two indices of the representative policy based on degrees of improvement of the two indices of the representative policy as an edge connecting the two nodes to generate an importance graph 2001 of the representative policy modeling the degrees of relative importance between the two indices of the representative policy, and in the calculation process, the processor calculates the degree of importance of each of the plurality of indices of the representative policy as the importance level based on the importance graph 2001 for each of the policy groups.

In this way, the number of policies can be reduced, and the calculation load can be reduced.

In the policy decision support apparatus 103 according to (1), in the generation process, the processor 201 performs normalization so that a sum of values indicating superiority or inferiority of a specific edge indicating a direction from each node of the graph to another node becomes 1, and in the calculation process, the processor 201 calculates an eigenvector based on the graph as the importance level of each of the plurality of indices A to C.

In this way, the model is normalized, and the relationship between the plurality of indices A to C can be quantified.

In the policy decision support apparatus 103 according to (1), the processor 201 executes: an output process of outputting the graph by distinguishing a color or size of the node according to an attribute of the index and distinguishing a thickness of the edge according to the superiority or inferiority.

In this way, the state of the model can be visually perceived.

In the policy decision support apparatus 103 according to (1), the processor 201 executes: a first acquisition process of acquiring a degree of relative importance between the two indices based on responses from residents within a target area of the policy, in the generation process, the processor 201 executes a first generation process of expressing each of the plurality of indices as a first node and expressing the degree of relative importance between the two indices as a first edge connecting the two first nodes to generate a value graph 1000 showing values of the residents modeling the degree of relative importance between the two indices, in the calculation process, the processor 201 executes a first calculation process of calculating a degree of preference indicating a preference relationship of the plurality of indices as the importance level based on the value graph, the processor 201 executes: a second acquisition process of acquiring a degree of relative importance between the two indices based on responses from the residents within the target area of the policy, in the generation process, the processor 201 executes a second generation process of expressing each of the plurality of indices as a second node and expressing the degree of relative importance between the two indices based on the degrees of improvement of the two indices as a second edge connecting the two second nodes to generate an importance graph 2001 of the policy modeling the degrees of relative importance between the two indices, in the calculation process, the processor 201 executes a second calculation process of calculating the degrees of importance of the plurality of indices as the importance levels based on the importance graph 2001, and the processor 201 executes: a quantification process of calculating a degree of preference compatibility indicating how much the preference relationship of the plurality of indices is compatible with the degree of relative importance between the plurality of indices based on the degree of preference calculated in the first calculation process and the degree of importance calculated in the second calculation process.

In this way, it is possible to construct a relationship in which the superiority or inferiority between each index and another index is ranked based on the degree of relative importance given by the resident R. Therefore, it is possible to quantify the preference relationships among the plurality of indices A to C. In addition, it is possible to construct a relationship in which the superiority or inferiority between each index and another index is ranked based on the degree of relative importance given by the policy proposing party (the business operator B). Therefore, it is possible to quantify the relationship of which index is considered more important among the plurality of indices A to C. In this way, it is possible to quantify the preference order of values and the improvement order of the degree of importance.

In the policy decision support apparatus 103 according to (9), in the quantification process, the processor 201 calculates a degree of matching of the values with respect to the policy based on the degree of preference compatibility and a degree of statistical improvement based on the degrees of improvement of the plurality of indices.

In this way, it is possible to identify to what extent the policy developed by the policy proposing party (the business operator B) match the values of the residents R and to quantify the social value of the business of the policy.

In the policy decision support apparatus 103 according to (10), in the quantification process, the processor 201 calculates the degree of preference compatibility for each of the policies, calculates the degree of statistical improvement for each of the policies, and calculates the degree of matching for each of the policies.

In this way, it is possible to identify which policy developed by a policy proposing party (the business operator B) and to what extent the policy matches the values of the residents R and to quantify the social value of the business for each policy.

In the policy decision support apparatus 103 according to (11), in the quantification process, the processor 201 decides a policy optimal for the values based on the degree of matching for each policy.

In this way, it is possible to identify the policy that best matches the values of the residents R.

In the policy decision support apparatus 103 according to (9), in the first generation process, the processor 201 performs normalization so that a sum of the degrees of importance of a specific first edge indicating a direction from each first node of the value graph 1000 to another first node becomes 1, in the first calculation process, the processor 201 calculates a first eigenvector based on the value graph 1000 as the degree of preference indicating the preference relationship of the plurality of indices, in the second generation process, the processor 201 performs normalization so that a sum of the degrees of importance of a specific second edge indicating a direction from each second node of the importance graph 2001 to another second node becomes 1, in the second calculation process, the processor 201 calculates a second eigenvector based on the importance graph 2001 as the degree of importance of each of the plurality of indices, and in the quantification process, the processor 201 calculates the degree of preference compatibility based on a vector distance between the first eigenvector and the second eigenvector.

In this way, quantification can be achieved by comparing the degree of preference indicating the preference order of values and the degree of improvement indicating the improvement order of the degree of importance.

It should be noted that this disclosure is not limited to the above-mentioned embodiments, and encompasses various modification examples and the equivalent configurations within the scope of the appended claims without departing from the gist of this disclosure. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A policy decision support apparatus that includes a processor configured to execute a program and a storage device configured to store the program, and is configured to support policy decision based on a plurality of indices,
the processor being configured to execute:
a generation process of expressing the plurality of indices as nodes and expressing, for every two indices among the plurality of indices, superiority or inferiority between the two indices as an edge connecting the two nodes to generate a graph modeling a relationship between the plurality of indices; and
a calculation process of calculating an importance level of each of the plurality of indices based on the graph generated in the generation process.

2. The policy decision support apparatus according to claim 1,
the processor being configured to execute:
an acquisition process of acquiring a degree of relative importance between the two indices based on responses from residents within a target area of the policy,
wherein in the generation process, the processor is configured to express the plurality of indices as nodes and expresses the degree of relative importance between the two indices as an edge connecting the two nodes to generate a value graph showing values of the residents, modeling the degree of relative importance between the two indices, and
wherein in the calculation process, the processor is configured to calculate a degree of preference indicating a preference relationship of the plurality of indices as the importance level based on the value graph.

3. The policy decision support apparatus according to claim 2,
wherein in the generation process, the processor is configured to generate the value graph by inputting feature amount vectors corresponding to the two indices to a machine learning device that predicts the responses.

4. The policy decision support apparatus according to claim 1,
wherein the processor being configured to execute:
an acquisition process of acquiring, for each of the indices, a degree of improvement of the policy based on a result of a simulation of the policy using a plurality of parameters in a target area of the policy,
wherein in the generation process, the processor is configured to express each of the plurality of indices as nodes and expresses the degree of relative importance between the two indices based on the degrees of improvement of the two indices acquired in the acquisition process as an edge connecting the two nodes to generate an importance graph of the policy modeling a degree of relative importance between the two indices, and
wherein in the calculation process, the processor is configured to calculate the degree of importance of each of the plurality of indices as the importance level based on the importance graph.

5. The policy decision support apparatus according to claim 4,
wherein in the acquisition process, the processor is configured to acquire, for each of the indices, the result of a simulation using the plurality of parameters for each of the plurality of policies, and acquire, for each of the indices, a degree of improvement of each policy by normalizing a difference between a result of a simulation of a reference policy among the plurality of policies and a result of a simulation of another policy based on the difference and a direction in which the result is improved,
wherein in the generation process, the processor is configured to generate the importance graph for each of the policies, and
wherein in the calculation process, the processor is configured to calculate the degree of importance of each of the plurality of indices for each of the policies based on the importance graph.

6. The policy decision support apparatus according to claim 4, wherein
wherein in the acquisition process, the processor is configured to acquire, for each of the indices, the degree of improvement of each of the plurality of policies, and groups policies having similar degrees of improvement of the policy for each of the indices into policy groups,
wherein in the generation process, the processor is configured to express a plurality of indices of a representative policy which is one of the policies in each of the policy groups as nodes and expresses a degree of relative importance between two indices of the representative policy based on degrees of improvement of the two indices of the representative policy as an edge connecting the two nodes to generate an importance graph of the representative policy modeling the degrees of relative importance between the two indices of the representative policy, and
wherein in the calculation process, the processor is configured to calculate the degree of importance of each of the plurality of indices of the representative policy as the importance level based on the importance graph for each of the policy groups.

7. The policy decision support apparatus according to claim 1,
wherein in the generation process, the processor is configured to perform normalization so that a sum of values indicating superiority or inferiority of a specific edge indicating a direction from each node of the graph to another node becomes 1, and
wherein in the calculation process, the processor is configured to calculate an eigenvector based on the graph as the importance level of each of the plurality of indices.

8. The policy decision support apparatus according to claim 1,
wherein the processor being configured to execute:
an output process of outputting the graph by distinguishing a color or size of the node according to an attribute of the index and distinguishing a thickness of the edge according to the superiority or inferiority.

9. The policy decision support apparatus according to claim 1,
wherein the processor is configured to execute:
a first acquisition process of acquiring a degree of relative importance between the two indices based on responses from residents within a target area of the policy,
wherein in the generation process, the processor is configured to execute a first generation process of expressing each of the plurality of indices as a first node and expressing the degree of relative importance between the two indices as a first edge connecting the two first nodes to generate a value graph showing values of the residents modeling the degree of relative importance between the two indices,
wherein in the calculation process, the processor is configured to execute a first calculation process of calculating a degree of preference indicating a preference relationship of the plurality of indices as the importance level based on the value graph,
wherein the processor being configured to execute:
a second acquisition process of acquiring a degree of relative importance between the two indices based on responses from the residents within the target area of the policy,
wherein in the generation process, the processor is configured to execute a second generation process of expressing each of the plurality of indices as a second node and expressing the degree of relative importance between the two indices based on the degrees of improvement of the two indices as a second edge connecting the two second nodes to generate an importance graph of the policy modeling the degrees of relative importance between the two indices,
wherein in the calculation process, the processor is configured to execute a second calculation process of calculating the degrees of importance of the plurality of indices as the importance levels based on the importance graph, and
wherein the processor being configured to execute:
a quantification process of calculating a degree of preference compatibility indicating how much the preference relationship of the plurality of indices is compatible with the degree of relative importance between the plurality of indices based on the degree of preference calculated in the first calculation process and the degree of importance calculated in the second calculation process.

10. The policy decision support apparatus according to claim 9,
wherein in the quantification process, the processor is configured to calculate a degree of matching of the values with respect to the policy based on the degree of preference compatibility and a degree of statistical improvement based on the degrees of improvement of the plurality of indices.

11. The policy decision support apparatus according to claim 10,
wherein in the quantification process, the processor is configured to calculate the degree of preference compatibility for each of the policies, calculate the degree of statistical improvement for each of the policies, and calculate the degree of matching for each of the policies.

12. The policy decision support apparatus according to claim 11,
wherein in the quantification process, the processor is configured to determine a policy optimal for the values based on the degree of matching for each policy.

13. The policy decision support apparatus according to claim 9,
wherein in the first generation process, the processor is configured to perform normalization so that a sum of the degrees of importance of a specific first edge indicating a direction from each first node of the value graph to another first node becomes 1,
wherein in the first calculation process, the processor is configured to calculate a first eigenvector based on the value graph as the degree of preference indicating the preference relationship of the plurality of indices,
wherein in the second generation process, the processor is configured to perform normalization so that a sum of the degrees of importance of a specific second edge indicating a direction from each second node of the importance graph to another second node becomes 1,
wherein in the second calculation process, the processor is configured to calculate a second eigenvector based on the importance graph as the degree of importance of each of the plurality of indices, and
wherein in the quantification process, the processor is configured to calculate the degree of preference compatibility based on a vector distance between the first eigenvector and the second eigenvector.

14. A policy decision support method executed by a policy decision support apparatus that includes a processor configured to execute a program and a storage device configured to store the program, and is configured to support policy decision based on a plurality of indices,
the policy decision support method allowing:
the processor to execute:
a generation process of expressing the plurality of indices as nodes and expressing, for every two indices among the plurality of indices, superiority or inferiority between the two indices as an edge connecting the two nodes to generate a graph modeling a relationship between the plurality of indices; and
a calculation process of calculating an importance level of each of the plurality of indices based on the graph generated in the generation process.
